(19) United States
(12) Patent Application Publication
(10) Pub. No.: US 2016/0344449 A1
(43) Pub. Date: Nov. 24, 2016

(54) COMMUNICATION HUB SYSTEM

(71) Applicant: Vango Technologies, Inc., Hangzhou (CN)

(72) Inventor: Ching-Kae TZOU, Hangzhou (CN)

(73) Assignee: Vango Technologies, Inc., Hangzhou (CN)

(21) Appl. No.: 14/860,059

(22) Filed: Sep. 21, 2015

(30) Foreign Application Priority Data
May 22, 2015 (CN) 201510267557.6

(51) Int. Cl. H04B 3/54; H04L 5/22

(52) U.S. Cl. CPC H04B 3/54; H04L 5/22

(57) ABSTRACT

A communication hub system is provided, which includes a wireless communication unit, a power line communication unit and a host unit. The wireless communication unit supports multiple preset wireless standards, and selects, based on a wireless network time-division multiplexing rule, the wireless standard corresponding to a target communication device for performing signal transmission and receiving. The power line communication unit supports at least one preset power line standard, and receives or transmits a signal via a power line. The host unit controls to select the power line communication unit and/or the wireless communication unit to perform the signal transmission and receiving under a target standard.

### CROSS REFERENCES OF RELATED APPLICATIONS

The present application claims the priority to Chinese Patent Application No. 201510267557.6, titled “COMMUNICATION HUB SYSTEM”, filed on May 22, 2015 with the State Intellectual Property Office of People's Republic of China, which is incorporated herein by reference in its entirety.

### FIELD

The disclosure relates to the field of communication system, and in particular to a communication hub system.

### BACKGROUND

There are multiple wireless standards for wireless network technology, such as ZigBee, Bluetooth and WiFi, and the multiple wireless standards may be applicable to various communication areas and communication conditions. However, there are still some communication areas in which the wireless communication can not to be performed with those standards of wireless technology. For example, radio wave may be blocked or weakened by some obstacles in a basement of a building so that wireless communication quality can not be ensured.

Power line communication (PLC) is a general designation of all technologies in which power lines are used as communication channels. A PLC communication system transmits data via modulated communication signals on existing power lines, and the power lines are also used to supply power to residences, buildings and other places. In this case, the communication devices can be networked without newly added wires or cables. The power line communication also has different standards. However, power line noise in the power line communication may result in a poor propagation environment.

The existing communication method has poor compatibility and interoperability for different communication environments and communication standards.

### SUMMARY

In this regard, the major object of the present disclosure is to provide a communication hub, for selecting, based on channel quality for signal transmission, one or both of wireless communication mode and power line communication mode for communication, thereby improving compatibility and interoperability of communication.

To achieve the above-described object, a communication hub system is provided according to the present disclosure, which includes:

a wireless communication unit, a power line communication unit and a host unit;

the wireless communication unit supports multiple preset wireless standards, and is configured to select, based on a wireless network time-division multiplexing rule, a wireless standard corresponding to a target communication device for performing signal transmission and receiving;

the power line communication unit supports at least one preset power line standard, and is configured to perform signal transmission and receiving via a power line; and

the host unit is configured to select the power line communication unit and/or the wireless communication unit to perform the signal transmission and receiving under a target standard.

Preferably, the wireless communication unit and the power line communication unit may be each connected to the host unit.

Preferably, the wireless communication unit may include a multiband antenna sub-unit, a radio frequency transmission sub-unit and a radio frequency receiving sub-unit;

the multiband antenna sub-unit is configured to communicate with an antenna signal in a preset frequency band.

Preferably, the power line communication unit may include a transformer, a line driver sub-unit and an analog circuit. Specifically, the analog circuit is configured to couple a signal received from the power line and a signal transmitted to the power line.

Preferably, in a case that the wireless communication unit is selected to perform the signal transmission and receiving, the wireless communication unit may select, based on the time-division multiplexing rule, the plurality of preset wireless standards to communicate with respective target communication devices correspondingly.

Preferably, in a case that both the wireless communication unit and the power line communication unit are selected to perform the signal transmission and receiving, the wireless communication unit and the power line communication unit may be each connected to a target communication device, and the communication unit may share a power line communication channel with the target device based on the time-division multiplexing rule.

A communication hub system according to the present disclosure includes a wireless communication unit, a power line communication unit and a host unit. Specifically, the wireless communication unit supports multiple preset wireless standards, and selects, based on a wireless network time-division multiplexing rule, the wireless standard corresponding to a target communication device for performing signal transmission and receiving. The power line communication unit supports at least one preset power line standard, and receives and transmits a signal via a power line. The host unit controls to select the power line communication unit and/or the wireless communication unit to perform the signal transmission and receiving under a target standard. Specifically, the power line is used for signal transmission and receiving. In the case that the communication is performed with a power line communication front-end, the power line is used for signal transmission and receiving; while in the case that the communication is performed with a radio frequency module, a wireless channel is used for signal transmission and receiving under a wireless standard corresponding to a target communication device, which is selected based on a wireless network time-division multiplexing rule. Thus, communication may be conduct with a suitable communication mode selected based on different signal transmission conditions and different communication devices, thereby improving the compatibility and the interoperability of communication.

### BRIEF DESCRIPTION OF THE DRAWINGS

The appended drawings to be used in the description of the embodiments or the conventional technology will be described briefly as follows, so that the technical solutions according to the embodiments of the present disclosure or according to the conventional technology will become clearer. It is obvious that the appended drawings in the following description only illustrate some embodiments of the present disclosure. For those skilled in the art, other appended drawings may be obtained according to these appended drawings without any creative work.

FIG. 1 is a schematic structural diagram of a communication hub system according to a first embodiment of the present disclosure;

FIG. 2 is a schematic principle diagram of the communication hub system according to the first embodiment of the present disclosure; and

FIG. 3 is a schematic principle diagram of a communication hub system according to a second embodiment of the present disclosure.

### DETAILED DESCRIPTION OF THE EMBODIMENTS

The technical solution according to the embodiments of the present disclosure will be described clearly and completely as follows in conjunction with the appended drawings. It is obvious that the described embodiments are only a few rather than all of the embodiments according to the present disclosure. Any other embodiments obtained by those skilled in the art based on the embodiments in the present disclosure without any creative work fall in the scope of the present disclosure.

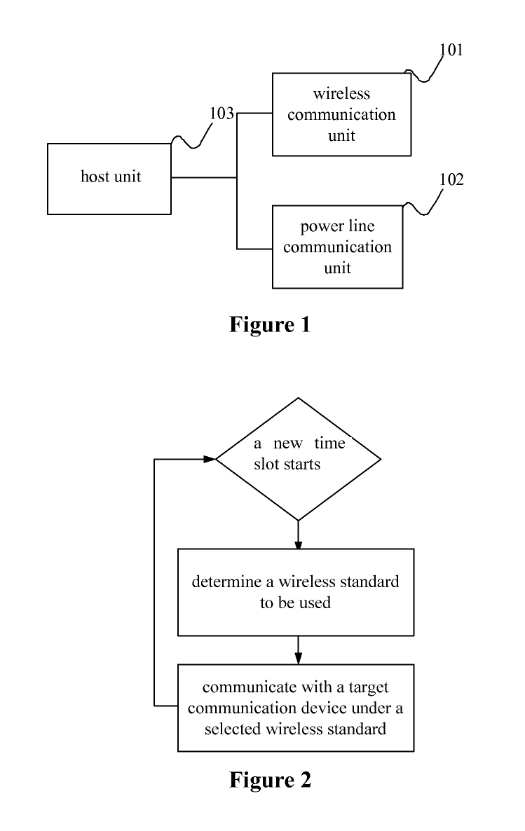

A communication hub system is provided according to the present disclosure. FIG. 1 shows a schematic structural diagram of a first embodiment of a communication hub system according to the present disclosure. The communication hub system includes a wireless communication unit 101, a power line communication unit 102 and a host unit 103.

Specifically, the wireless communication unit 101 supports multiple preset wireless standards, and is configured to select, based on a wireless network time-division multiplexing rule, the wireless standard corresponding to a target communication device for performing signal transmission and receiving.

The wireless communication unit 101 is able to support compatibly multiple wireless standards, i.e., multiple wireless communication standard protocols, such as ZigBee, Bluetooth and WiFi. Under the time-division multiplexing rule, different signals are transmitted in different time periods. Specifically, different wireless standards may be introduced to a wireless channel based on signals in the different time periods. As shown in FIG. 2, a communication device selects the supported wireless standard for communication from a new time slot; a duration of one time slot is set freely, the communication device communicates with another device supporting the same wireless standard in one time slot, and then switching to a new wireless standard is performed for communication when the new time slot starts.

The power line communication unit 102 supports at least one preset power line standard, and is configured to receive or transmit a signal via a power line.

The power line communication unit 102 is able to support compatibly one or more of power line communication standard protocols, such as IEEE1901.2, PRIME, G3, G.hnem, or the like.

The host unit 103 is configured to select the power line communication unit and/or the wireless communication unit to perform the signal transmission and receiving under a target standard.

In this embodiment, each of the wireless communication unit 101 and the power line communication unit 102 is connected to the host unit 103, and the selection of the two communication modes are controlled via the host unit 103.

The communication hub system according to an embodiment includes a wireless communication unit 101, a power line communication unit 102 and a host unit 103. Specifically, the wireless communication unit 101 supports multiple preset wireless standards, and is configured to select, based on a wireless network time-division multiplexing rule, the wireless standard corresponding to a target communication device for performing signal transmission and receiving. The power line communication unit 102 supports at least one preset power line standard, and is configured to receive or transmit a signal via a power line. The host unit 103 is configured to select the power line communication unit and/or the wireless communication unit to perform the signal transmission and receiving under a target standard. In the case that the communication is performed with a power line communication front-end, the power line is used for signal transmission and receiving; while in the case that the communication is performed with a radio frequency module, a wireless channel is used for signal transmission and receiving under a wireless standard corresponding to a target communication device, which is selected based on a wireless network time-division multiplexing rule. Thus, communication may be conduct with a suitable communication mode selected based on different signal transmission conditions and different communication devices, thereby improving the compatibility and the interoperability of communication.

Corresponding to the above-described first embodiment, in a communication hub system according to a second embodiment of the present disclosure, the wireless communication unit includes a multiband antenna sub-unit, a radio frequency transmission sub-unit and a radio frequency receiving sub-unit.

The multiband antenna sub-unit is configured to communication with an antenna signal in a preset frequency band.

A frequency range of the multiband antenna sub-unit is generally not limited, and a main working frequency band includes: 315 MHz, 433 MHz, 868 MHz and 915 MHz and the like.

The power line communication unit includes a transformer, a line driver sub-unit and an analog circuit, where the analog circuit is configured to couple a signal received from the power line and couple a signal transmitted to the power line.

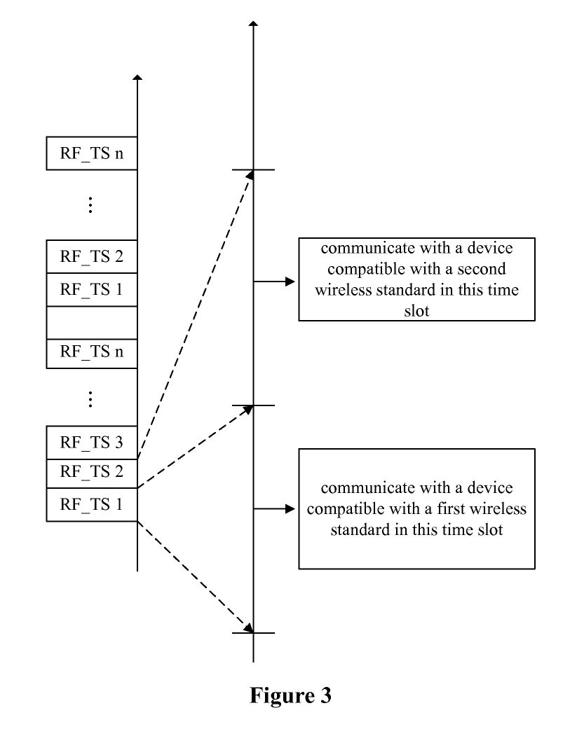

In this embodiment, in the case that the wireless communication unit is selected to perform the signal transmission and receiving, the wireless communication unit selects, based on the time-division multiplexing rule, a plurality of preset wireless standards to communicate with different target communication devices correspondingly. For example, as being bridged between communication devices, a first communication device supports a first wireless standard and a second wireless standard, communicates with a second communication device supporting the first wireless standard in one time slot period, and communicates with a third communication device supporting the second wireless standard in another time slot period, as shown in FIG. 3.

In a case that both the wireless communication unit and the power line communication unit are selected to perform the signal transmission and receiving, the wireless communication unit and the power line communication unit are each connected to the target communication device, and the communication devices share the power line communication channel based on the time-division multiplexing rule.

It should be noted that, the embodiments in this specification are described in a progressive way, each of which emphasizes the differences from others, and the same or similar parts among the embodiments can be referred to each other.

Finally, it should be noted that the relationship terminologies such as “first”, “second” and the like are only used herein to distinguish one entity or operation from another, rather than to necessitate or imply that an actual relationship or order exists between the entities or operations. Furthermore, terms of “include”, “comprise” or any other variants are intended to be non-exclusive. Therefore, a process, method, article or device including a plurality of elements includes not only the disclosed elements but also other elements that are not clearly enumerated, or also include inherent elements of the process, method, article or device. Unless expressively limited otherwise, the statement “including a . . . ” does not exclude the case that other similar elements may exist in the process, method, article or device other than enumerated elements.

The systems according to the embodiments of the disclosure are introduced in detail above, the principles and implementing ways of the disclosure are clarified by specific examples, and the above illustration of the embodiments is only to help to understand the method and key idea of disclosure. In addition, those skilled in the art may make changes to the specific embodiments and the application scope based on the idea of the disclosure. In summary, the specification should not be understood as limitations to the disclosure.

1. A communication hub system, comprising:
a wireless communication unit, a power line communication unit and a host unit, wherein:
the wireless communication unit supports a plurality of preset wireless standards, and is configured to select, based on a wireless network time-division multiplexing rule, a wireless standard corresponding to a target communication device for performing signal transmission and receiving;
the power line communication unit supports at least one preset power line standard, and is configured to perform signal transmission and receiving via a power line; and
the host unit is configured to select at least one of the power line communication unit and the wireless communication unit to perform the signal transmission and receiving under a target standard.

2. The communication hub system according to claim 1, wherein the wireless communication unit and the power line communication unit are each connected to the host unit.

3. The communication hub system according to claim 2, wherein the wireless communication unit comprises a multiband antenna sub-unit, a radio frequency transmission sub-unit and a radio frequency receiving sub-unit, and
the multiband antenna sub-unit is configured to transmit and receive an antenna signal in a preset frequency band.

4. The communication hub system according to claim 3, wherein the power line communication unit comprises a transformer, a line driver sub-unit and an analog circuit, wherein the analog circuit is configured to couple a signal received from the power line and a signal transmitted to the power line to the power line communication unit.

5. The communication hub system according to claim 4, wherein in a case that the wireless communication unit is selected to perform the signal transmission and receiving, the wireless communication unit selects, based on the time-division multiplexing rule, the plurality of preset wireless standards to communicate with different target communication devices correspondingly.

6. The communication hub system according to claim 4, wherein in a case that both the wireless communication unit and the power line communication unit are selected to perform the signal transmission and receiving, the wireless communication unit and the power line communication unit are each connected to the target communication device; the hub and the target communication device share a power line communication channel based on the time-division multiplexing rule.
